(19) United States
(12) Patent Application Publication
(10) Pub. No.: US 2007/0268809 A1
(43) Pub. Date: Nov. 22, 2007

(54) Wire isolation apparatus for record playback system

(76) Inventor: Chien-Chung Chen, Taichung (TW)

Correspondence Address: Chien-Chung Chen, P.O. Box 55-846, Taipei 104, Taiwan, Taipei, 104, omitted

(21) Appl. No.: 11/434,821

(22) Filed: May 17, 2006

(51) Int. Cl. G11B 17/00; G11B 21/16

(52) U.S. Cl. 369/247.1

(57) ABSTRACT

A wire isolation apparatus for a record playback system includes a plurality of lead wires having a first end of the lead wires connected to a phono cartridge of a tone arm on a turntable, and a second end of the lead wires connected to at least a terminal connectable to an amplifier or pre-amplifier, with the lead wires separated from the tone arm and held to a suspending device which is separated from the tone arm and the turntable so as to be isolated from the vibration and noise sources of the tone arm and the turntable, thereby causing no distortion when communicating or transferring the signals as picked up by the phono cartridge.

### BACKGROUND OF THE INVENTION

In a conventional record playback system, the lead wires or phono cables are installed in a tone arm mounted on a turntable, which however may have the following drawbacks:
1. The vibration caused by the rotating turntable may be transferred to the lead wires, as mounted within the tone arm or remained in contact with the tone arm, to interfere with the signal communication as picked up from the phono cartridge, thereby causing distortion of the signals and deteriorating the audio quality.
2. The lead wires as “limited” within the tone arm may be mutually scratched frictionally to easily produce noise, thereby deteriorating the audio quality.
3. Even if the wires are juxtapositionally or externally secured to the tone arm, the vibration hazard may still exist to thereby influence the audio quality.

The present inventor has found the drawbacks of the prior art and invented the present wire Isolation apparatus to improve the defects of the prior art.

### SUMMARY OF THE INVENTION

The object of the present invention is to provide a wire isolation apparatus for a record playback system, including a plurality of lead wires (or phono cables) having a first end of the lead wires connected to a phono cartridge of a tone arm mounted on a turntable, and a second end of the lead wires connected to at least a terminal connected to a pre-amplifier or an amplifier, with the lead wires separated from the tone arm and held to a suspending device which is separated from the tone arm and the turntable so as to be isolated from the vibration and noise sources of the tone arm and the turntable, thereby causing no distortion when communicating or transferring the signals as picked up by the phono cartridge.

### BRIEF DESCRIPTION OF THE DRAWINGS

FIG. 1 is a top view illustration of the present invention.

FIG. 2 is an elevational illustration of the present invention.

FIG. 3 is a partial sectional drawing of the suspending device of the present invention.

FIG. 4 is an illustration showing the arrangement of the lead wires in accordance with the present invention.

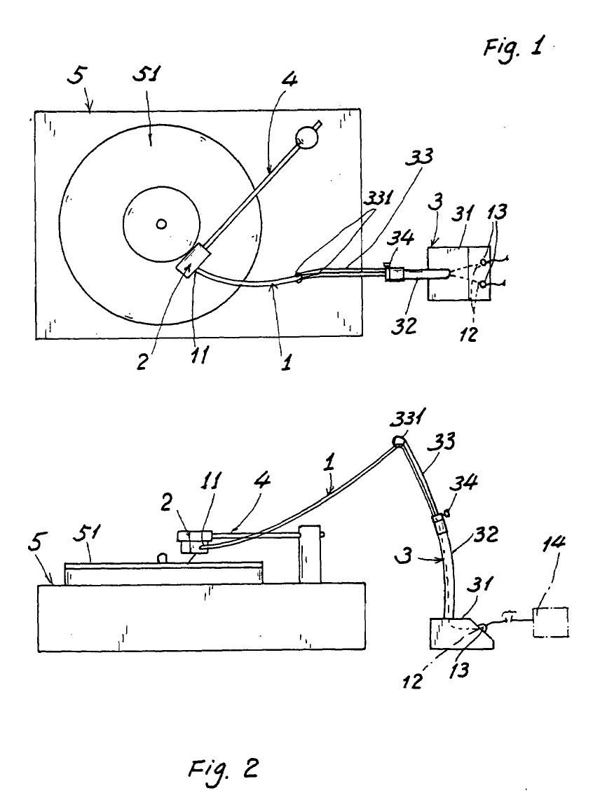

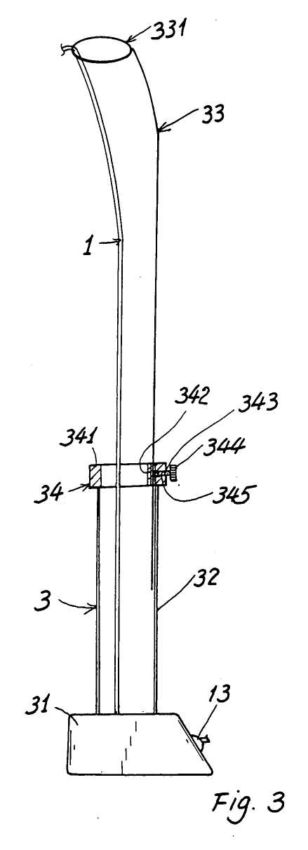

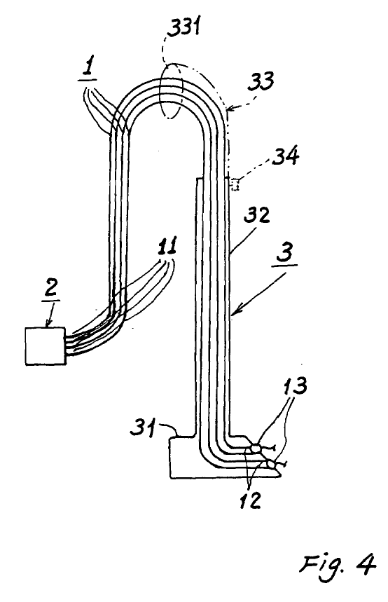

### DETAILED DESCRIPTION

As shown in the drawing figures, the present invention comprises: a plurality of lead wires (or phono cables) 1 connected between a phono cartridge 2 and a suspending device 3.

The phono cartridge 2 is secured to a tone arm 4 mounted on a turntable 51 of a record playback system 5, for instance, a vinyl record playback system.

The lead wires 1 include a first end 11 thereof connected to the phono cartridge 2, and a second end 12 of the lead wires 11 connected to a pair of terminals 13 formed on the suspending device 3. The terminals 13 are connectable to a pre-amplifier or an amplifier (not shown).

The major wire portion (except the first end 11 and the second end 12) of the lead wires 1 is separated from the tone arm 4 and the turntable 51 of the record playback system 5.

The suspending device 3 is also separated or isolated from the turntable 51 of the record playback system 5.

The suspending device 3 includes: a base 31 having the terminals 13 of the second end 12 of the lead wires 1 formed on the base 31, a hollow tube 32 protruding upwardly from the base 31 for passing the lead wires 1 through an interior in the hollow tube 32, and a cantilever 33 mounted on the hollow tube 32 for suspendibly hanging the lead wires 1 as originated from the cartridge 2 and led into the hollow tube 32.

The suspending device 3 further includes: an adjusting means 34 mounted on the hollow tube 32 for variably adjusting height of the cantilever 33 as being raised or lowered in the hollow tube 32 to thereby adjust the height of the lead wires 1 as hung by the cantilever 33.

The hollow tube 32 is preferably formed as a flexible tube which can be easily oriented for adjusting the orientations, heights or positions of the lead wires 1 when isolated from the tone arm 4.

The cantilever 33 is preferably formed as a wire or fine rod having a loop 331 formed on a top of the cantilever 33 for hanging the lead wires 1 and for passing the lead wires 2 through the loop 331.

The loop 331 may also be modified as a hook or other suitable structures, not limited in the present invention.

The cantilever 33 may also be eliminated if the hollow tube 32 is formed with proper height or flexibility; or even the tube 32 is pivotally or universally secured to the base 31 of the suspending device 3.

The adjusting means 34 includes: a collar 341 secured or formed on the hollow tube 32, a vertical hole 342 vertically formed through the collar 341 for slidably passing the cantilever 33 through the vertical hole 342, a locking screw 343 having a knob 344 secured on an outer portion of the locking screw 343 rotatably engaged in a lateral hole 345 which is laterally formed through the collar 341 to be generally perpendicular to and communicated with the vertical hole 342, whereby upon rotation of the knob 344 of the locking screw 343 to inwardly protrude the screw 343 to “bite” (or to be engaged with) the cantilever 33 held in the vertical hole 342, the cantilever 33 will be locked by the screw 343 to be positioned at a desired height above the hollow tube 32.

By adjusting the height of the cantilever 33 and the orientation of the tube 32, the lead wires 1 will be optimumly suspended or hung at a suitable location or position as isolated or separated from the tone arm 4 or the turntable 51.

The adjusting means 34 may be further modified or eliminated in the present invention. For instance, the cantilever 33 may be integrally formed or secured with an U-shaped or V-shaped clip (not shown) to be resiliently retained in the hollow tube 32 after being adjusted at a height above the base 31 of the suspending device 3.

The lead wires 1 of the present invention have been isolated or separated from the tone arm 4 and the turntable 51 of the record playback system 5 so that the vibration interference or noise as caused from the tone arm 4 or turntable 51 may be precluded or prevented, thereby ensuring a qualified signal transfer from the cartridge to the pre-amplifier or the amplifier without distortion or deterioration.

The suspending device 3 of the present invention is provided to suspendibly hang, hold or guide the major portion of the lead wires 1 (except the first end 11 and the second end 12 of the wires 1) to prevent from any tangling or blocking of the wires with or by the elements of the record playback system or record player, thereby providing a better maneuverability for operating the playback system of the present invention without being interfered.

The lead wires 1 are distally separated from any vibrational or frictional parts or elements of the record playback system, thereby ensuring a qualified audio signal communication without distortion to thereby be superior to the prior arts.

The present invention may be further modified without departing from the spirit and scope of the present invention.

I claim:

1. A wire isolation apparatus for record playback system comprising:
a plurality of lead wires having a first end thereof connected to a phono cartridge secured to a tone arm mounted on a turntable of the record playback system, and having a second end of the lead wires connected to at least a terminal which is connectable to an amplifier or a pre-amplifer;
said lead wires having a major wire portion, defined between the first end and the second end of the lead wires, suspendibly held by a suspending device and separated from the tone arm to preclude any vibrational and noise source from the tone arm and the turntable to thereby cause no distortion of signals as transferred in the record playback system.

2. A wire isolation apparatus according to claim 1, wherein said suspending device includes: a base having the terminal of the second end of the lead wires formed on the base, a hollow tube protruding upwardly from the base for passing the lead wires through an interior in the hollow tube, and a cantilever mounted on the hollow tube for suspendibly hanging the lead wires as originated from the cartridge and led into the hollow tube.

3. A wire isolation apparatus according to claim 2, wherein said suspending device further includes: an adjusting means mounted on the hollow tube for variably adjusting height of the cantilever as being raised or lowered in the hollow tube to thereby adjust height of the lead wires as hung by the cantilever.

4. A wire isolation apparatus according to claim 1, wherein said hollow tube is formed as a flexible tube which is oriented for adjusting the orientations, heights or positions of the lead wires when isolated from the tone arm.

5. A wire isolation apparatus according to claim 2, wherein said cantilever is formed as a rod having a loop formed on a top of the cantilever for hanging the lead wires and for passing the lead wires through the loop.

6. A wire isolation apparatus according to claim 3, wherein said adjusting means includes: a collar formed on the hollow tube, a vertical hole vertically formed through the collar for slidably passing the cantilever through the vertical hole, a locking screw having a knob secured on an outer portion of the locking screw rotatably engaged in a lateral hole which is laterally formed through the collar to be generally perpendicular to and communicated with the vertical hole, whereby upon rotation of the knob of the locking screw to inwardly protrude the screw to be engaged with the cantilever held in the vertical hole, the cantilever will be locked by the screw to be positioned at a desired height above the hollow tube.

7. A wire isolation apparatus according to claim 2, wherein said suspending device includes a base and a hollow tube formed on said base for directing the lead wires as originated from the phono cartridge into the hollow tube to be connected to the terminal formed on said base.
